(19) United States
(12) Patent Application Publication
(10) Pub. No.: US 2012/0291589 A1
(43) Pub. Date: Nov. 22, 2012

(54) VARIABLE INERTIA FLYWHEEL

(76) Inventors: Vijayaselvan Jayakar, Bangalore (IN); Sumit Kumar Das, Bangalore (IN)

(21) Appl. No.: 13/112,728

(22) Filed: May 20, 2011

(51) Int. Cl. F16F 15/167; F16F 15/30

(52) U.S. Cl. 74/573.1; 74/572.21

(57) ABSTRACT

A flywheel includes a disc-shaped flywheel body having a peripheral surface defining a circumference of the flywheel body, a central hub connected to the body for mounting the flywheel on a crankshaft or other flywheel support, and a plurality of chambers in the flywheel body radially spaced from the central hub and angularly spaced about the circumference of the flywheel body.

### FIELD OF THE INVENTION

Embodiments of the invention relate generally to flywheels and, more particularly, to flywheels for marine vessels.

### BACKGROUND OF THE INVENTION

Vehicles and vessels, such as trucks, heavy machinery, and river-going ships and boats, are used for a variety of tasks. These vehicles and vessels may include a transmission coupled to an engine, such as an internal combustion engine, that provides the power to complete these tasks. The transmission may be mechanical, hydro-mechanical, hydraulic, or an electric transmission that transmits engine power to a traction device or, in the case of a marine vessel, a propeller. The power load placed on the transmission by the propeller or traction device is transmitted to the engine. Power load changes, either requiring additional power or less power, may cause the engine to deviate from a desired operating range. As will be readily appreciated, deviations from the desired speed range may result in poor efficiency, less power production, and increased wear on the engine.

In internal combustion engines, a flywheel may be used to store energy during the power stroke of the engine and return that energy during other strokes. In marine applications, such as marine vessels and river-going ships powered by internal combustion engines, flywheel inertia facilitates a smooth engagement of the clutch to the propeller and minimizes variations in engine speed caused by a change in the power load.

The magnitude of the variations in engine speed may be minimized by increasing the inertia of the flywheel and the engine inertia in general. As flywheel inertia (and thus engine inertia) increases, however, the responsiveness of the engine decreases. Transient response, i.e., the time it takes the engine to go from idle to full speed under application loads, also increases. Indeed, every 100 kg·m² moment of inertia increase may increase transient response (i.e., decrease engine responsiveness) by 2 seconds.

Transient response is of particular importance in connection with marine vessels such as river-going ships. For example, a low transient response time helps avoid collisions due to drifting of the vessel in river currents and waves, and to drive quickly upstream. Moreover, reduction in transient response time results in a safer vessel because it can be more precisely controlled, and results in decreased overall trip duration. Conventional flywheels, however, may be inefficient at providing a balance between minimizing engine speed fluctuations and allowing the engine to respond quickly to desired power changes.

### BRIEF DESCRIPTION OF THE INVENTION

An embodiment of the present invention relates to a flywheel. The flywheel includes a disc-shaped flywheel body having a peripheral surface defining a circumference of the flywheel body, a central hub connected to the body for mounting the flywheel on a crankshaft or other shaft or other flywheel support, and a plurality of chambers in the flywheel body radially spaced from the central hub and angularly spaced about the circumference of the flywheel body.

According to one aspect, when the flywheel is installed and in operation in an engine system, the chambers are filled with a fluid when the engine is being idled at low speed. Conversely, the chambers are drained (or partially drained) of the fluid when the engine is being accelerated. Thus, flywheel and engine rotating inertia is large when the engine is being idled at low speed, but small when high engine torque response characteristics are required, such as when the engine is being accelerated. This minimizes the variations in engine speed caused by a change in the power load, while additionally providing an increased level of engine responsiveness.

Another embodiment relates to a marine vessel having a variable inertia flywheel. The marine vessel includes an engine having at least one piston, a crankshaft connected to the engine and translating linear motion of the at least one piston into rotation, a propulsion device operatively connected to the engine, and a variable inertia flywheel fixedly secured to the crankshaft. The flywheel includes a flywheel body having a peripheral surface defining a circumference of the flywheel body, a central hub connected to the body and dimensioned to receive the crankshaft, and a plurality of chambers in the flywheel body radially spaced from the central hub and angularly spaced about the circumference of the flywheel body.

Another embodiment relates to a method for varying the inertia moment of a flywheel, e.g., instead in a marine vessel or otherwise. The method includes selectively filling a plurality of chambers of a flywheel with a fluid to increase the inertia moment of the flywheel. The flywheel comprises a flywheel body having a peripheral surface defining a circumference, a central hub connected to the body, and the plurality of chambers. The chambers are in the body and are radially spaced from the central hub and angularly spaced along the peripheral surface. The method further includes draining the fluid from the plurality of chambers, e.g., in dependence upon an angular velocity of the flywheel.

### BRIEF DESCRIPTION OF THE DRAWINGS

The present invention will be better understood from reading the following description of non-limiting embodiments, with reference to the attached drawings, wherein below:

FIG. 1 is a schematic side elevation view of a marine vessel having a variable inertial flywheel according to an embodiment of the present invention.

FIG. 2 is a side elevational view of a crankshaft and the flywheel of the marine vessel of FIG. 1.

FIG. 3 is an end elevational view of the crankshaft and flywheel of FIG. 2.

FIG. 4 is a cross-sectional view of the flywheel of the marine vessel taken along line A-A of FIG. 2.

FIG. 5 is a perspective, cross-sectional view of the flywheel of the marine vessel taken along line A-A of FIG. 2.

FIG. 6 is a graph illustrating transient response at various angular velocities of flywheels having differing moments of inertia in accordance with an embodiment of the present invention.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts. Although exemplary embodiments of the present invention are described with respect to marine vessels, embodiments of the invention are also applicable for use with work machines generally, meaning any truck, vehicle or other heavy machinery that utilizes an engine to provide power.

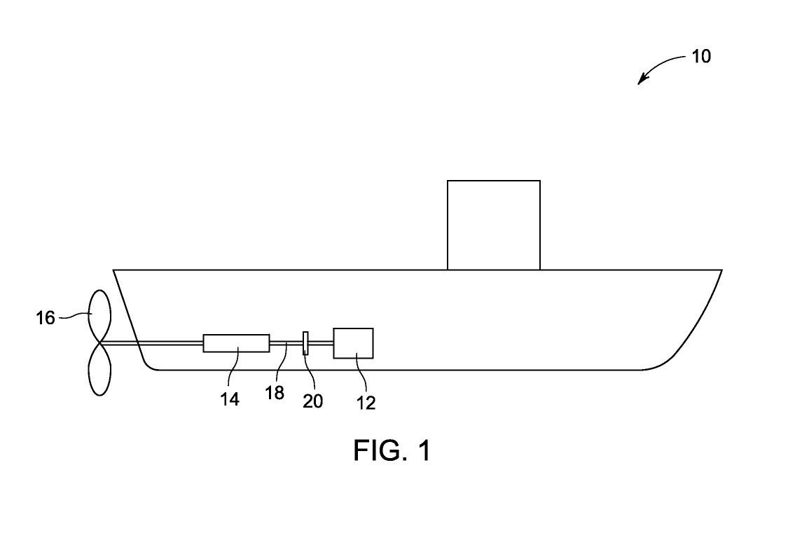

FIG. 1 is a schematic illustration of a marine vessel 10 in accordance with an embodiment of the present invention. As shown therein, the marine vessel 10 includes an engine 12 and a transmission 14 connected to a propulsion device of the marine vessel. In an embodiment, the propulsion device is at least one propeller 16. In an embodiment, the engine 12 is an internal combustion engine, such as a gasoline engine, diesel engine, or natural gas engine, although engines of other types may also be utilized without departing from the broader aspects of the present invention. In addition, the transmission 14 may be a mechanical, electric, or other transmission known in the art.

As shown therein, a crankshaft 18 extends from the engine and translates the reciprocating linear piston motion of the engine into rotation. The marine vessel 10 further includes a flywheel 20, described in detail below, that is mounted to the crankshaft 18.

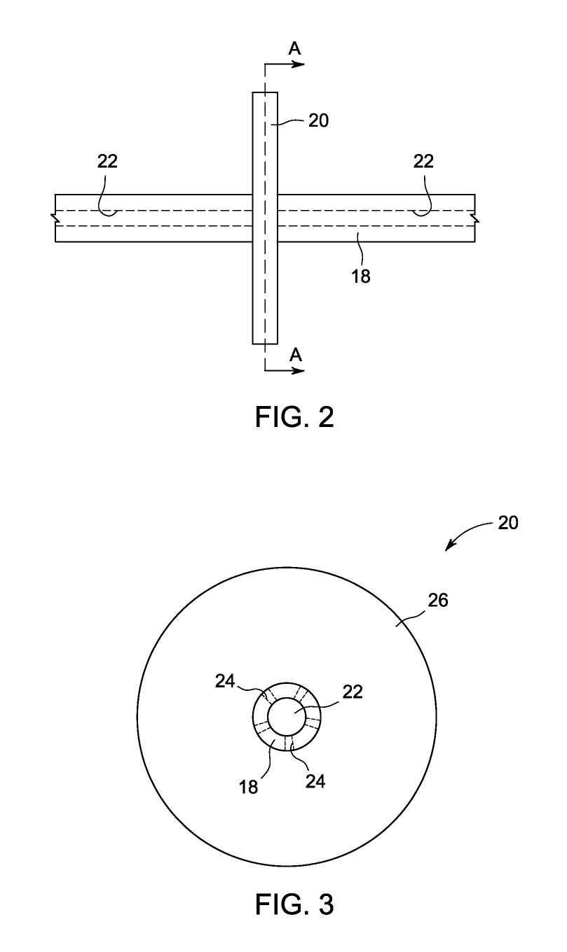

Referring now to FIGS. 2 and 3, detail views of the crankshaft 18 and flywheel 20 according to an embodiment of the present invention are shown. The crankshaft 18 is generally hollow and includes a longitudinal passageway 22 extending therethrough for providing a flow of fluid to the flywheel 20. In an embodiment, the fluid is engine oil from a supply manifold, although other fluids and supply sources are certainly possible without departing from the broader aspects of the present invention. As will be readily appreciated, engine oil is readily accessible in the engine 12 and therefore allows for easy implementation of the present invention. The crankshaft 18 further includes a plurality of apertures 24 extending from the passageway 22 to the peripheral surface of the crankshaft 18 at a point along its length where the flywheel 20 is mounted.

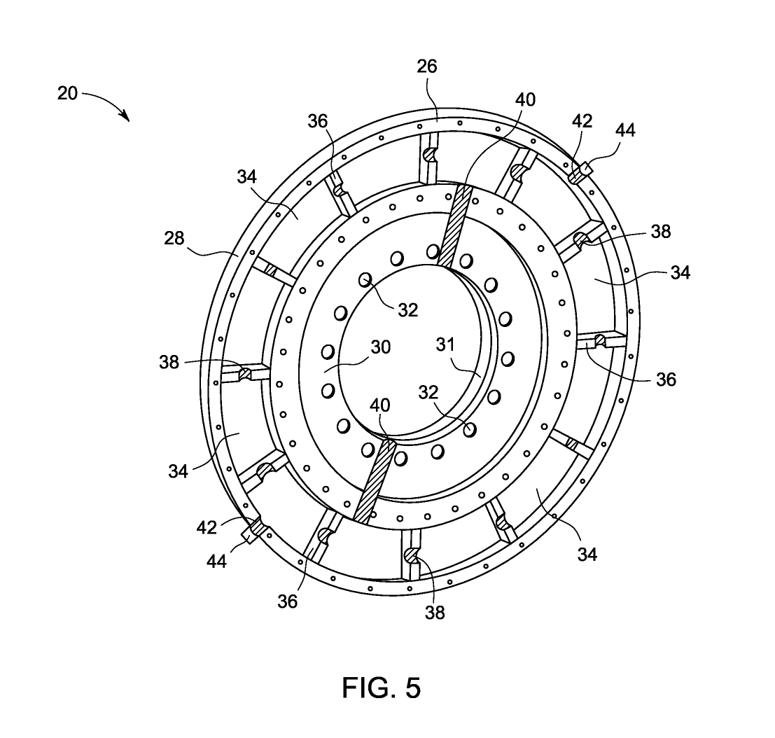

As best shown in FIGS. 3-5, the flywheel 20 has a generally disc-shaped body 26 having an outer peripheral surface 28 that defines a circumference of the body. A central hub 30 is connected to the body and defines an inner surface 31 (e.g., radially innermost surface) of the flywheel 20. The flywheel 20 is connected to the engine crankshaft 18 (or other another shaft or other support) by means known in the art such as by providing crank bolts (not shown) or the like though apertures 32 in the flywheel body 26 adjacent the hub 30 to connect the flywheel 20 to a portion of the crankshaft 18 (e.g., flanges provided on the crankshaft). The central hub 30 may be a separate element connected to the body. Alternatively, the central hub may be formed in the body, and thereby part of and connected to the body by virtue of being formed in the body. For example, the central hub may comprise the rim of a central aperture formed in and through the flywheel body.

As further shown therein, the flywheel 20 includes a plurality of interior chambers 34 within the flywheel body 26. The chambers 34 may be generally rectangular in shape, and/or sides of the chambers may be rounded in correspondence with the shape of the circular periphery of the flywheel body. In an embodiment, the chambers are radially spaced from the central hub 30 and angularly spaced about the circumference of the flywheel body 26. In an embodiment, the flywheel body 26 has twelve chambers 34, although more or fewer chambers may be utilized without departing from the broader aspects of the present invention. The chambers 34 are separated from one another by relatively thin, radially extending walls 36. That is, the two chambers of each pair of adjacent chambers are separated from one another by a radial wall 36, which extends in a radial direction of the body 26. A respective throughbore 38 is formed in each radial wall 36 such that each of the chambers 34 is in fluid communication with the other chambers 34. As will be readily appreciated, these throughbores 38 allow fluid to move freely from one chamber 34 to the next during rotation of the flywheel 20.

In addition, a supply port 40 extends from the inner surface 31 of the flywheel body 26, i.e., though the central hub 30, to one of the chambers 34. In another embodiment, there may be a plurality of supply ports 40 providing passageways from the inner surface 31, through central hub 30, to the chambers 34. In other embodiments, each chamber 34 may have a supply port 40 defining a passageway through the central hub 30 to each chamber 34. As discussed below, each supply port 40 is in fluid communication with an aperture 24 of the crankshaft 18 for receiving a fluid therefrom.

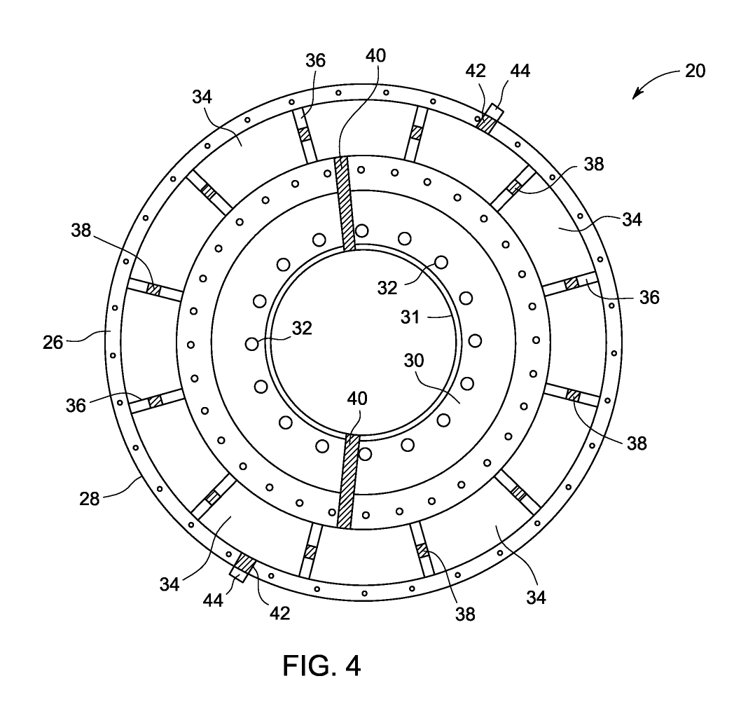

As best shown in FIG. 4, an exit port 42 is formed in the outer wall of at least one of the plurality of chambers 34 and provides a passageway from the chambers 34 to the outer peripheral surface 28 of the flywheel body 26. In an embodiment, only one of the chambers 34 includes an exit port 42. In another embodiment, each of the chambers 34 includes an exit port 42 providing a passageway from each chamber 34 to the peripheral surface 28 of the flywheel body 26. In yet other embodiments, some of the chambers 34, but not all, include an exit port 42.

As shown, a check valve 44 is positioned within each exit port 42. In an embodiment, the check valve 44 is a spring-loaded valve such as a ball check valve, although other types of valves known in the art may also be used without departing from the broader aspects of the present invention. In an embodiment, the check valve 44 is a two-port valve having one opening for fluid to enter and one opening for the fluid to exit. In any event, the check valve 44 inherently has a cracking pressure, which is the minimum upstream pressure at which the valve will operate. In these embodiments, the check valve 44 may be selected or configured to actuate, i.e., open to allow flow, at a specific cracking pressure. The valve 44 may be a check valve or other type of valve configured to perform a function as described herein.

In operation, prior to starting the engine 12, a fluid, such as engine oil, is directed through the crankshaft passageway 22, through the apertures 24 in the crankshaft 18, through the supply ports 40 and into the chambers 34 of the rotating flywheel 20. A predetermined amount of engine oil fills the chambers 34 of the flywheel 20 during clutch engagement as the flywheel 20 rotates. As the flywheel 20 rotates, the fluid in the chambers 34 is pushed towards the peripheral surface 28 of the flywheel 20. This increases the moment of inertia of the flywheel 20, which helps to minimize the variations in engine speed caused by a change in the power load, especially at idle or low speeds.

Subsequent to clutch engagement, when sudden power demand is required and power is transferred to the propeller to increase speed, the rotational velocity of the crankshaft 18, and thus the flywheel 20, increases. As the rotational velocity of the flywheel 20 increases, the fluid within the chambers 34 exerts a greater force or pressure on the outer wall, and the check valves 44, of the flywheel 20. Once the cracking pressure of the check valves 44 is reached, which corresponds to a predetermined rotational velocity (rpm) of the flywheel 20, the check valves 44 open, thereby allowing the fluid to drain from the chambers 34. As the fluid drains from the chambers 34, the moment of inertia of the flywheel 20 decreases, thereby allowing the engine 12 to respond quickly to desired power changes. As will be readily appreciated, by decreasing the moment of inertia of the flywheel 20 at times of power demand, e.g., during hard acceleration and sudden power demand, transient response is improved. In particular, by decreasing the moment of inertia of the flywheel by draining the chambers 34 of fluid, the time it takes the engine to go from idle to full speed under application loads is decreased.

In addition, once the engine 12 returns to low speed or idle, the chambers 34 of the flywheel 20 may once again be filled with fluid (e.g., engine oil) to again increase the moment of inertia thereof to facilitate smooth operation at low speed and idle conditions, and to ensure smooth engagement of the clutch to the heavy propeller.

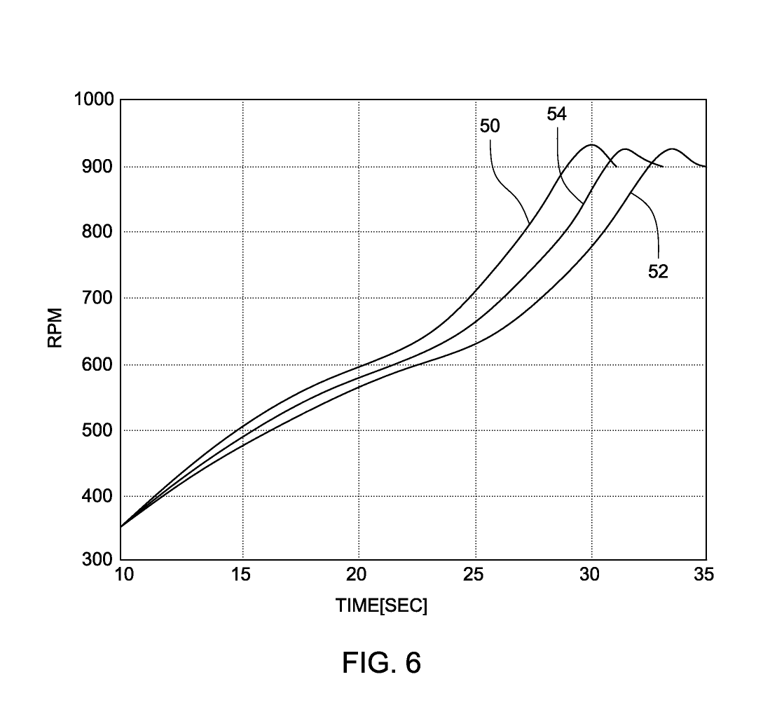

FIG. 6 illustrates transient response time at various angular velocities (measured in revolutions per minute) of a flywheel with different moments of inertia. As shown therein and as discussed above, curve 54 represents the base line transient response time, and curve 52 represents the transient response time of a flywheel having a moment of inertia of 200 kg·m², as a function of angular velocity. Curve 52 may represent the oil-filled flywheel 20. Curve 50 represents the transient response time of a flywheel having a moment of inertia of 100 kg·m², as a function of angular velocity. This curve 50 may represent the flywheel after the oil has been drained.

As shown in FIG. 6 for a 100 kg·m² decrease in moment of inertia (e.g., from 200 kg·m² to 100 kg·m² as shown), transient response time is improved by approximately 2 seconds (i.e., engine responsiveness is increased). Accordingly, by lowering the moment of inertia of the flywheel 20 at times of acceleration or sudden power demand, responsiveness is increased (i.e., transient response time is decreased). As will be readily appreciated, this is advantageous, especially in situations where transient response time is important, such as when a ship must quickly change accelerate to avoid collisions due to river currents, etc. Indeed, if the engine 12 is not able to pick up fast enough, it may become difficult to control the speed and direction of the ship. Moreover, it is crucial that the engine 12 produces enough power, as close to on-demand/instantaneously as possible, to counter the force and momentum of waves and current. Accordingly, by reducing flywheel inertia, and thus overall engine inertia, when instantaneous power production is needed, overall performance and responsiveness of the engine increased.

An embodiment of the present invention relates to a flywheel. The flywheel includes a disc-shaped flywheel body having a peripheral surface defining a circumference of the flywheel body, a central hub formed in or otherwise connected to the body for mounting the flywheel on a crankshaft or other shaft, the central hub defining an inner surface of the flywheel body, and a plurality of chambers in the flywheel body radially spaced from the central hub and angularly spaced about the circumference of the flywheel body. The chambers may be separated from one another by radial walls. A respective throughbore may be formed in each radial wall such that each of the plurality of chambers is in fluid communication with other chambers. An exit port may be formed in an outer wall of one of the plurality of chambers and provides a passageway from the chamber to the peripheral surface of the flywheel body. A check valve may be positioned within the exit port to regulate a flow of fluid from the chamber through the exit port away from the central hub. In an embodiment, the check valve may be a spring-loaded valve. The check valve may be selectively actuatable in dependence upon an angular velocity of the flywheel. The flywheel may also include an exit port formed in an outer wall of each of the chambers. In addition, the flywheel may include a supply port formed in the flywheel body and extending radially from the inner surface to one of the chambers and in fluid communication with an aperture in the crankshaft for directing a fluid from the crankshaft to the chambers. The fluid may be engine oil. In other embodiments, there may be a plurality of supply ports formed in the flywheel body extending from the inner surface of the central hub to each of the chambers, wherein each of the plurality of ports is in fluid communication with a corresponding aperture in the crankshaft and defines a passageway from the engine to the chambers.

Another embodiment of the present invention relates to a marine vessel having a variable inertia flywheel. The marine vessel includes an engine having at least one piston, a crankshaft connected to the engine and translating linear motion of the at least one piston into rotation, a propulsion device operatively connected to the engine; and a variable inertia flywheel fixedly secured to the crankshaft, the flywheel including a flywheel body having a peripheral surface defining a circumference of the flywheel body, a central hub formed in or otherwise connected to the body and dimensioned to receive the crankshaft, the central hub defining an inner surface of the flywheel body, and a plurality of chambers in the flywheel body radially spaced from the central hub and angularly spaced about the circumference of the flywheel body. The chambers may be separated from one another by radially extending walls each having a respective throughbore such that the chambers are in fluid communication with one another. The flywheel of the marine vessel may further include an exit port formed in an outer wall of one of the plurality of chambers to provide a passageway from the chamber to the peripheral surface of the flywheel body, and a check valve positioned within the exit port for regulating a flow of fluid from the chamber through the exit port away from the central hub in dependence upon an angular velocity of the flywheel. The check valve may be a spring-loaded check valve, such as a spring-loaded ball check valve. Moreover, the flywheel of the marine vessel may also include a supply port formed in the flywheel body and extending radially from the inner surface to one of the chambers and in fluid communication with an aperture in the crankshaft for directing a fluid from the crankshaft to the chambers.

Another embodiment of the present invention relates to a method for varying the inertia moment of a flywheel, e.g., a flywheel of a marine vessel. The method includes the step of selectively filling a plurality of chambers with a fluid to increase the inertia moment of the flywheel. The flywheel has a peripheral surface defining a circumference, a central hub defining an interior surface, and the plurality of chambers, which are in the body and radially spaced from the central hub and angularly spaced along the peripheral surface. The step of selectively filling the plurality of chambers may include directing engine oil from an engine, through a passageway in a crankshaft and into the chambers through a supply port formed in the central hub. The method may further include the step of draining the fluid from the chambers to decrease the inertia moment of the flywheel. In an embodiment, the fluid is drained from the chambers in dependence upon an angular velocity of the flywheel. In another embodiment, a check valve regulates the draining of fluid from the plurality of chambers. In another embodiment, the fluid is drained from the chambers in dependence upon an angular velocity of the flywheel, and a check valve regulates the draining of fluid from the plurality of chambers.

In an embodiment, a flywheel comprises a flywheel body, a central hub connected to the body, and a plurality of chambers in the flywheel body. Each of the plurality of chambers is radially spaced from the central hub, meaning each is positioned between the central hub and a peripheral, radially outermost surface of the flywheel body. Further, the chambers are angularly spaced about a circumference of the flywheel body, e.g., the body scribes a circle, and the chambers are arrayed around the circle and spaced apart from one another. The chambers may be regularly angularly spaced, e.g., for 12 chambers, every 30 degrees, or they may be irregularly spaced.

In an embodiment, a flywheel comprises a flywheel body, a central hub connected to the body, and a plurality of chambers in the flywheel body. The flywheel body is disc-shaped, meaning it is circular in radial cross section (plane perpendicular to a central axis of the body) and has a radius that is greater than a height of the body, e.g., 4× greater or more.

In another embodiment, a flywheel comprises a disc-shaped flywheel body having a peripheral surface defining a circumference of the flywheel body, a central hub, and a plurality of chambers in the flywheel body. The central hub is connected to the body for mounting the flywheel on a crankshaft or other shaft. The chambers are radially spaced from the central hub and angularly spaced about the circumference of the flywheel body. According to one aspect, the hub may define a radially innermost surface of the body, e.g., if the body is provided with an aperture for receiving a shaft, such as shown in FIG. 4. Alternatively, according to another aspect, the body may have an uninterrupted center, with the hub being connected to the center of the body via one or more fasteners, and with the hub otherwise providing a structure for connecting a shaft to the flywheel. For example, the hub could have a blind hole or bore for receiving the end of a shaft, or two such blind holes or bores for receiving the ends of adjacent segments of a multi-part shaft system. For this purpose, the hub could include plural hub sub-components, such as one that mounts to one side of the body and another that mounts to the other side of the body. In any such embodiments, the hub and/or body could be outfitted with mating internal passages for routing fluid from a shaft interior to the chambers 34.

Although certain embodiments herein as described in regards to crankshafts, other embodiments are applicable to shafts and other supports of a flywheel more generally.

Another embodiment relates to a flywheel. The flywheel comprises a disc-shaped flywheel body having a peripheral surface defining a circumference of the flywheel body. The flywheel additionally comprises a central hub connected to the body for mounting the flywheel on a flywheel support. The flywheel additionally comprises a plurality of interior chambers in the flywheel body radially spaced from the central hub and angularly spaced about the circumference of the flywheel body. The chambers are separated from one another by a plurality of radial walls. A respective throughbore extends through each radial wall such that the chambers are in fluid communication with one another. The flywheel further comprises at least one supply port in at least one of the body or the hub for directing a fluid from a source external to the flywheel to the plurality of chambers. The flywheel further comprises at least one exit port in the flywheel body. Each exit port provides a passageway from the chambers to the peripheral surface of the flywheel body. The flywheel further comprises a respective valve positioned within each exit port; the valve is configured to regulate a flow of fluid from the chambers through the exit port away from the central hub. In another embodiment, each valve is selectively actuatable in dependence upon an angular velocity of the flywheel.

Another embodiment relates to a method of varying the inertia moment of a flywheel. The flywheel is operatively connected to an engine or other propulsion system. The method includes selectively filling a plurality of chambers of a flywheel with a fluid to increase the inertia moment of the flywheel, upon occurrence of a first operational mode of the propulsion system (such as an operational mode where greater propulsion system stability, e.g., reduced variations in engine speed, is desired). The flywheel comprises a flywheel body having a peripheral surface defining a circumference, a central hub connected to the body, and the plurality of chambers. The chambers are in the body and radially spaced from the central hub and angularly spaced along the peripheral surface. The method additionally comprises draining the fluid from the plurality of chambers to decrease the inertia moment of the flywheel, upon occurrence of a second, different operational mode of the propulsion system (such as an operational mode where increased propulsion system responsiveness is desired).

Another embodiment relates to a method of retrofitting a marine vessel, other vehicle, or other engine-based system with a flywheel such as described in any of the embodiments set forth herein. The method includes disassembling an engine system (of the marine vessel, other vehicle, or other engine-based system) to the extent required for accessing a location in the engine system where the flywheel will be installed, and installing the flywheel in that location. Disassembly may include removing an existing crankshaft, and replacing the crankshaft with a crankshaft and flywheel as described herein.

Another embodiment relates to a method of servicing a flywheel (and/or a marine vessel, other vehicle, or other engine-based system having a flywheel) as described in any of the embodiments set forth herein. The method comprises accessing the flywheel and at least one of: cleaning the flywheel or portion thereof; and/or removing a component of the flywheel and replacing the removed component with a new or refurbished component of a compatible type.

In any of the embodiments set forth herein, the step or operation of draining fluid from the interior chambers may be done automatically, based on valve configuration or control or otherwise.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of ordinary skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described variable inertia flywheel, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A flywheel, comprising:
a disc-shaped flywheel body having a peripheral surface defining a circumference of the flywheel body;
a central hub connected to the body for mounting the flywheel on a crankshaft or other flywheel support; and
a plurality of chambers in the flywheel body radially spaced from the central hub and angularly spaced about the circumference of the flywheel body.

2. The flywheel of claim 1, wherein:
the chambers are separated from one another by a plurality of radial walls.

3. The flywheel of claim 2, further comprising:
a respective throughbore extending through each radial wall such that each of the plurality of chambers is in fluid communication with others of the plurality of chambers.

4. The flywheel of claim 1, further comprising:
an exit port extending through an outer wall of at least one of the plurality of chambers, the exit port providing a passageway from said at least one of the plurality of chambers to the peripheral surface of the flywheel body.

5. The flywheel of claim 4, further comprising:
a check valve positioned within the exit port, the check valve configured to regulate a flow of fluid from the chamber through the exit port away from the central hub.

6. The flywheel of claim 5, wherein:
the check valve is a spring-loaded valve.

7. The flywheel of claim 5, wherein:
the check valve is selectively actuatable in dependence upon an angular velocity of the flywheel.

8. The flywheel of claim 1, wherein:
the central hub defines an inner surface of the flywheel body; and
the flywheel further comprises a supply port in the flywheel body and extending radially from the inner surface to one of the plurality of chambers, the supply port aligning with an aperture in the flywheel support for fluid communication with the aperture and for directing a fluid from the flywheel support to the plurality of chambers.

9. The flywheel of claim 8, wherein:
the fluid is engine oil.

10. A flywheel, comprising:
a disc-shaped flywheel body having a peripheral surface defining a circumference of the flywheel body;
a central hub connected to the body for mounting the flywheel on a flywheel support;
a plurality of interior chambers in the flywheel body radially spaced from the central hub and angularly spaced about the circumference of the flywheel body, wherein the chambers are separated from one another by a plurality of radial walls, and wherein a respective throughbore extends through each radial wall such that the chambers are in fluid communication with one another;
at least one supply port in at least one of the body or the hub for directing a fluid from a source external to the flywheel to the plurality of chambers;
at least one exit port in the flywheel body, each exit port providing a passageway from the chambers to the peripheral surface of the flywheel body; and
a respective valve positioned within each exit port, the valve configured to regulate a flow of fluid from the chambers through the exit port away from the central hub.

11. The flywheel of claim 10, wherein each valve is selectively actuatable in dependence upon an angular velocity of the flywheel.

12. A marine vessel comprising:
an engine having at least one piston;
a crankshaft connected to the engine and translating linear motion of the at least one piston into rotation;
a propulsion device operatively connected to the engine; and
a variable inertia flywheel fixedly secured to the crankshaft, the flywheel including a flywheel body having a peripheral surface defining a circumference of the flywheel body, a central hub connected to the body and dimensioned to receive the crankshaft, and a plurality of chambers in the flywheel body radially spaced from the central hub and angularly spaced about the circumference of the flywheel body.

13. The marine vessel of claim 12, wherein:
the chambers are separated from one another by a plurality of radial walls, each radially extending wall having a respective throughbore such that the plurality of chambers are in fluid communication with one another.

14. The marine vessel of claim 13, further comprising:
an exit port extending through an outer wall of one of the plurality of chambers, the exit port providing a passageway from the chambers to the peripheral surface of the flywheel body; and
a check valve positioned within the exit port, the check valve regulating a flow of fluid from the chambers through the exit port away from the central hub in dependence upon an angular velocity of the flywheel.

15. The marine vessel of claim 14, wherein:
the check valve is a spring-loaded check valve.

16. The marine vessel of claim 12, wherein:
the central hub defines an inner surface of the flywheel body; and
the marine vessel further comprises a supply port in the flywheel body and extending radially from the inner surface to one of the plurality of chambers, the supply port being in fluid communication with an aperture in the crankshaft for directing a fluid from the crankshaft to said one of the plurality of chambers.

17. A method of varying the inertia moment of a flywheel, the method comprising the steps of:
selectively filling a plurality of chambers of a flywheel with a fluid to increase the inertia moment of the flywheel, wherein the flywheel comprises a flywheel body having a peripheral surface defining a circumference, a central hub connected to the body, and the plurality of chambers, and wherein the chambers are in the body and radially spaced from the central hub and angularly spaced along the peripheral surface; and
draining the fluid from the plurality of chambers to decrease the inertia moment of the flywheel.

18. The method of claim 17, wherein the step of selectively filling the plurality of chambers comprises:
directing engine oil from an engine, through a passageway in a crankshaft and into the plurality of chambers through a supply port located in the central hub.

19. The method of claim 17, wherein:
a check valve regulates the draining of fluid from the plurality of chambers.

20. The method of claim 17, wherein the fluid is drained from the chambers in dependence upon an angular velocity of the flywheel.
